(19) United States
(12) Patent Application Publication
(10) Pub. No.: US 2017/0066375 A1
(43) Pub. Date: Mar. 9, 2017

(54) VEHICLE-MOUNTED DISPLAY DEVICE

(71) Applicant: MITSUBISHI ELECTRIC CORPORATION, Tokyo (JP)

(72) Inventors: Kiyotaka KATO, Tokyo (JP); Yasunori HOSHIHARA, Tokyo (JP)

(73) Assignee: MITSUBISHI ELECTRIC CORPORATION, Tokyo (JP)

(21) Appl. No.: 15/120,321

(22) PCT Filed: Apr. 17, 2014
(86) PCT No.: PCT/JP2014/060939

§ 371 Date: Aug. 19, 2016

(51) Int. Cl. B60R 1/00; G06K 9/00; G06T 3/40; G06T 11/60; H04N 5/232; H04N 7/18

(52) U.S. Cl. CPC B60R 1/00; H04N 5/23293; H04N 7/181; G06T 3/40; G06T 11/60; G06K 9/00805; B60R 2300/105; B60R 2300/303; B60R 2300/8093

(57) ABSTRACT

Disclosed is a vehicle-mounted display device 1 including a plurality of displays 9-1 to 9-m mounted in a vehicle, a plurality of operation receivers respectively corresponding to the plurality of displays 9-1 to 9-m, an image acquirer 3 to acquire a plurality of camera images from a plurality of externally-mounted cameras that shoot surroundings of the vehicle, an image processing controller 2a to, when one operation receivers accepts a passenger's operation of selecting a camera image to be displayed on the corresponding display from among the plurality of camera images, issue a command to generate image data to be displayed on the display, and an image integration processor 4 to, for each of the displays 9-1 to 9-m, select a camera image to be displayed on the display from among the plurality of camera images according to the command, to generate the image data.

### FIELD OF THE INVENTION

The present invention relates to a vehicle-mounted display device that displays camera images which are captured by shooting the surroundings of a vehicle on a display mounted in the vehicle.

### BACKGROUND OF THE INVENTION

By displaying camera images which are captured by shooting the surroundings of a vehicle on a display mounted in the vehicle, passengers are enabled to visually recognize an obstacle and an approaching object (another vehicle, a motorbike, a bicycle, a pedestrian, and so on) in front, rear, right and left side areas of the vehicle on the display. Therefore, a passenger seated next to the driver or a rear-seat passenger is enabled to check the conditions of the surroundings of the vehicle on the display and then notify the driver of the conditions and to use the conditions information for a safety check when getting out of the vehicle, and this leads to driving support for the driver.

For example, in vehicle-mounted electronic equipment disclosed in patent reference 1, when a rear seat seating detection sensor detects rear seat seating, a rear seat door opening motion detection sensor detects a rear seat door opening motion, and a moving object approach detection sensor detects an approach of a moving object, a controller commands a display for rear seat to display a warning about the opening of the rear seat door. The warning is a display of only character information, or a display of character information and the type of the approaching moving object.

Further, for example, in a vehicle surroundings monitoring system disclosed in patent reference 2, before a door of a vehicle in a state in which the vehicle is at rest is opened, an image of at least an area in the vicinity of the door of the vehicle is captured by using an imaging unit and is displayed on a display device mounted in the vehicle, and, when an approaching object detecting unit detects an approaching object in at least the area in the vicinity of the door of the vehicle, an image of the approaching object is displayed on the display device.

### RELATED ART DOCUMENT

### Patent Reference

Patent reference 1: Japanese Unexamined Patent Application Publication No. 2013-180634

Patent reference 2: Japanese Unexamined Patent Application Publication No. 2007-148618

### SUMMARY OF THE INVENTION

### Problems to be Solved by the Invention

Because in the vehicle-mounted electronic equipment disclosed in above-mentioned patent reference 1, pieces of information about all obstacles and all moving objects in the detection range of the sensor are displayed, in a text-based form, on the screen, the pieces of information are hard for passengers to intuitively comprehend, and therefore there is a possibility of causing passengers to get confused. A further problem with the vehicle-mounted electronic equipment and the vehicle surroundings monitoring system described in above-mentioned patent references 1 and 2 is that passengers are not allowed to freely select which camera image captured by shooting a portion of the surroundings of the vehicle is to be displayed on the screen, and no driving support based on the selection of a camera image can be provided for the driver.

The present invention is made in order to solve the above-mentioned problems, and it is therefore an object of the present invention to provide a vehicle-mounted display device that enables passengers to freely select a camera image which is captured by shooting the surroundings of a vehicle, and cause a display to display the camera image.

### Means for Solving the Problem

According to the present invention, there is provided a vehicle-mounted display device including: a plurality of displays mounted in a vehicle; a plurality of operation receivers respectively corresponding to the plurality of displays; an image acquirer to acquire a plurality of camera images from a plurality of externally-mounted cameras that shoot surroundings of the vehicle; an image processing controller to, when the operation receiver accepts a passenger's operation of selecting a camera image to be displayed on the display from among the plurality of camera images, issue an image processing command to generate image data to be displayed on the display corresponding to the above-mentioned operation receiver; and an image integration processor to, for each of the plurality of displays, select a camera image to be displayed on the above-mentioned display from among the plurality of camera images according to the image processing command from the image processing controller, to generate the image data.

### Advantages of the Invention

Because when accepting a passenger's operation of selecting a camera image to be displayed on a display from a plurality of camera images, the vehicle-mounted display device according to the present invention selects the camera image to be displayed on the display from the plurality of camera images and generates image data, the vehicle-mounted display device makes it possible for passengers freely to select a camera image and cause a display to display the selected camera image.

### BRIEF DESCRIPTION OF THE FIGURES

FIG. 1 is a block diagram showing the configuration of a vehicle-mounted display device according to Embodiment 1 of the present invention;

FIG. 2 is a diagram showing an example of the installation of externally-mounted cameras connected to an image acquirer according to Embodiment 1, and displays that display images captured by the externally-mounted cameras;

FIG. 3 is a diagram showing the installation situation of the displays shown in FIG. 2, which is viewed from the rear seat of a vehicle;

FIG. 4 is a diagram showing an example of a method of connecting image receivers according to Embodiment 1;

FIG. 5 is a diagram showing an example of the screen layout of a display connected to each of the image receivers according to Embodiment 1;

FIG. 6 is a diagram showing an example of screen transitions of a display connected to an image receiver according to Embodiment 1;

FIG. 7 is a diagram showing an example of screen transitions of a display connected to an image receiver according to Embodiment 1;

FIG. 8 is a diagram showing an example of a screen transition of a display connected to an image receiver according to Embodiment 1;

FIG. 9 is a diagram showing an example of a screen transition of a display connected to an image receiver according to Embodiment 1;

FIG. 10 is a flow chart showing the operation of the vehicle-mounted display device according to Embodiment 1;

FIG. 11 is a diagram explaining conditions inside and outside the vehicle in which the vehicle-mounted display device according to Embodiment 1 is mounted;

FIG. 12 is a diagram showing an example of menu operations on a display which a passenger performs under the conditions shown in FIG. 11, and screen transitions of the display;

FIG. 13 is a diagram showing an example of settings of buffers for performing an image grabbing process and an image integrating process by using an image integration processor according to Embodiment 1; and

FIG. 14 is a timing chart showing operations on a frame by frame basis and on a line by line basis of the image integration processor and an image transmission processor according to Embodiment 1.

### EMBODIMENTS OF THE INVENTION

Hereafter, in order to explain this invention in greater detail, the preferred embodiments of the present invention will be described with reference to the accompanying drawings.

### Embodiment 1

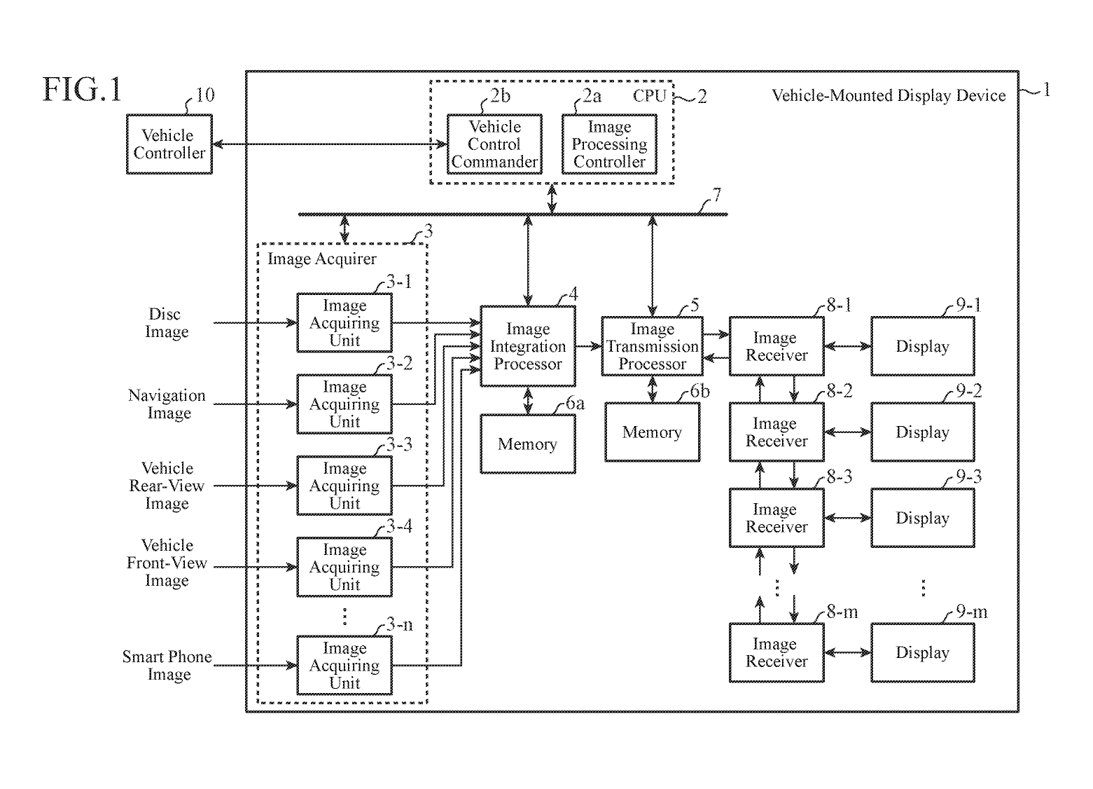

As shown in FIG. 1, a vehicle-mounted display device 1 according to Embodiment 1 includes a CPU (Central Processing Unit) 2 that controls the operation of the entire vehicle-mounted display device, an image acquirer 3 comprised of a plurality of image acquiring units 3-1 to 3-n, an image integration processor 4 that performs composition, integration, etc. on a plurality of images, an image transmission processor 5 that transmits image data to image receivers 8-1 to 8-m, the image receivers 8-1 to 8-m that receive the image data transmitted by the image transmission processor 5, and displays 9-1 to 9-m that display image data received thereby. Further, a vehicle controller 10 that controls vehicle-mounted equipment mounted in a vehicle and the vehicle-mounted display device 1 are connected to each other via an in-vehicle network.

The CPU 2 includes an image processing controller 2a that controls entire image processing of the vehicle-mounted display device 1, and a vehicle control commander 2b that issues a command to the vehicle controller 10 via the in-vehicle network. Further, although not illustrated, this CPU 2 includes an internal memory, an input/output port that exchanges information with peripheral equipment, and a network interface.

The image processing controller 2a acquires the number, the display sizes, the communication states, and the pieces of error information of the image receivers 8-1 to 8-m, among the pieces of status information about the image receivers 8-1 to 8-m which are stored in a memory 6b, via the image transmission processor 5 and an internal bus 7. The image processing controller 2a also acquires pieces of information each about a passenger's operation from the displays 9-1 to 9-m via the image receivers 8-1 to 8-m, the image transmission processor 5 and the internal bus 7. The image processing controller 2a controls the image integration processor 4 and the image transmission processor 5 on the basis of the acquired information.

The vehicle control commander 2b acquires, via the internal bus 7, detection information about an obstacle or an approaching object in the surroundings of the vehicle, the obstacle or the approaching object being detected by the image integration processor 4. The vehicle control commander 2b outputs a command to control an operation on the vehicle, such as a command to lock or unlock a door, the command being based on this detection information, to the vehicle controller 10 via the in-vehicle network. The vehicle controller 10 controls the door lock control system of the vehicle, or the like in accordance with the command from the vehicle control commander 2b, to perform locking or unlocking of a door, or the like.

The image acquirer 3 includes the n (n>=2) image acquiring units 3-1 to 3-n. Each of the image acquiring units 3-1 to 3-n performs pre-processing, such as color conversion and format conversion, on an image inputted thereto, and outputs the image to the image integration processor 4. As the image inputted, there is an image of the surroundings (a front, rear, right or left side area, or the like) of the vehicle which is captured by an externally-mounted camera. Further, for example, the vehicle-mounted display device 1 can also be used for RSE (Rear Seat Entertainment), and a disc image outputted from a disc device mounted in the vehicle, such as an image on a DVD (Digital Versatile Disc) or a BD (Blu-ray Disc; a registered trademark, and this description of the registered trademark will be omitted hereafter), a navigation image outputted from a navigation device, a smart phone image outputted from a smart phone connected to an external input terminal of the vehicle-mounted display device 1, or the like can be used as the inputted image.

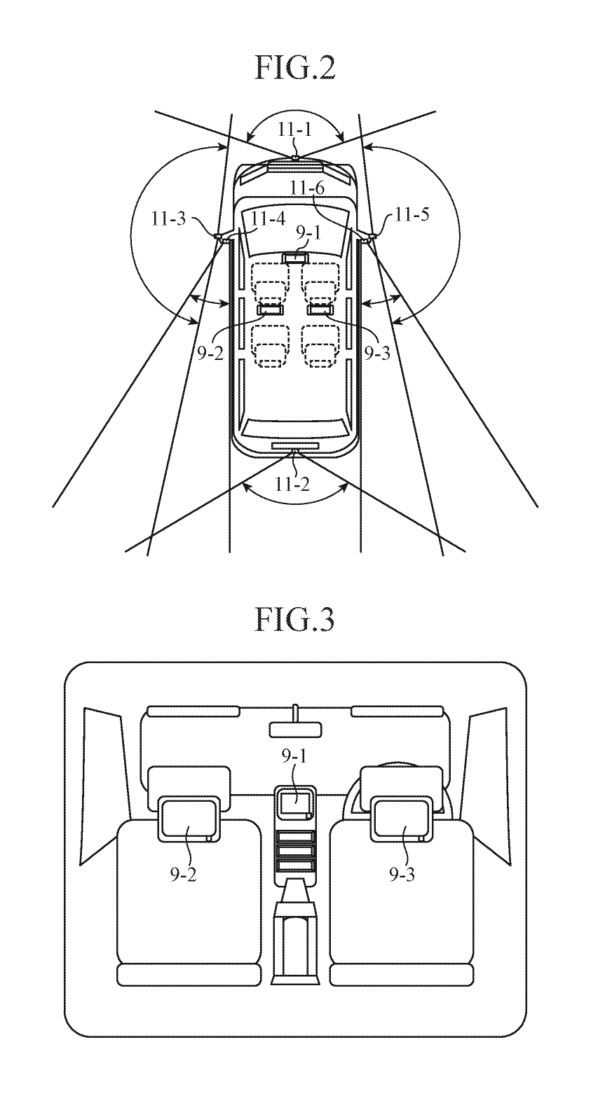

FIG. 2 shows an example of the installation of externally-mounted cameras connected to the image acquirer 3 and displays each of which displays an image which is captured by an externally-mounted camera. A front camera 11-1 that captures a front side area of the vehicle is mounted on the front of the vehicle, a rear camera 11-2 that captures a rear side area of the vehicle is mounted on the rear of the vehicle, a left side camera 11-3 that captures a left side area of the vehicle and a left rear camera 11-4 that captures a left rear side area of the vehicle are mounted on the left side door mirror of the vehicle, and a right side camera 11-5 that captures a right side area of the vehicle and a right rear camera 11-6 that captures a right rear side area of the vehicle are mounted on the right side door mirror of the vehicle. Further, as the displays connected to the image receivers 8-1 to 8-m, a front seat display 9-1 is mounted on the front center between the driver's seat and the front seat next to the driver, and a left rear seat display 9-2 and a right rear seat display 9-3 are mounted respectively on the rears of the driver's seat and the front seat next to the driver. FIG. 3 shows the installation situation of the front seat display 9-1, the left rear seat display 9-2 and the right rear seat display 9-3, which is viewed from the rear seat in the vehicle.

The number of cameras used and their installation positions can be changed dependently upon the angles of view, the degrees of definition, etc. of the cameras used.

The image integration processor 4 performs a process of integrating or compositing a plurality of images acquired by the image acquiring units 3-1 to 3-n, image processing for detecting a moving object and an obstacle from each of the images, a graphics drawing process of marking (coloring, emphasizing, or the like) the moving object and the obstacle, etc. The image integration processor 4 performs the processes in response to an image processing command, via the internal bus 7, from the image processing controller 2a, and stores the processed results of the image integrating process (image data) in the memory 6a. The image integration processor 4 also reads the image data on which the processes are performed from the memory 6a, and outputs the image data to the image transmission processor 5. Buffers for image capturing and buffers for image integrating process and display which are used by the image integration processor 4 are arranged in the memory 6a. The memory 6a can be disposed in outside the image integration processor 4, as shown in FIG. 1, or can be disposed within the image integration processor 4.

The image transmission processor 5 packetizes the image data received from the image integration processor 4 into packets as images to be displayed on the displays 9-1 to 9-m, and adds header information to each of the packets and transmits the packets. The image transmission processor 5 also receives the pieces of status information about the image receivers 8-1 to 8-m and the pieces of operation information about the displays 9-1 to 9-m, and stores them in the memory 6b. The image processing controller 2a reads the pieces of information stored in the memory 6b, thereby being able to recognize the pieces of status information about the image receivers 8-1 to 8-m and the pieces of operation information.

To the m (m≧2) image receivers 8-1 to 8-m, the m displays 9-1 to 9-m are connected, respectively. Further, the image receivers 8-1 to 8-m are cascaded. Each of the image receivers selects and receives the packet data destined for itself from among the packet data transmitted from the image transmission processor 5, and transmits the packet data to the image receivers cascaded downstream therefrom. The image receivers 8-1 to 8-m output and display the image data included in the received packet data on the displays 9-1 to 9-m. The m displays 9-1 to 9-m can be connected to the m image receivers 8-1 to 8-m, respectively, as mentioned above, or the image receivers 8-1 to 8-m and the displays 9-1 to 9-m can be configured integrally.

In the case that the image receiver 8-1 to 8-m are cascaded, as shown in FIG. 1, there is provided an advantage of being able to easily change the number of cascaded image receivers.

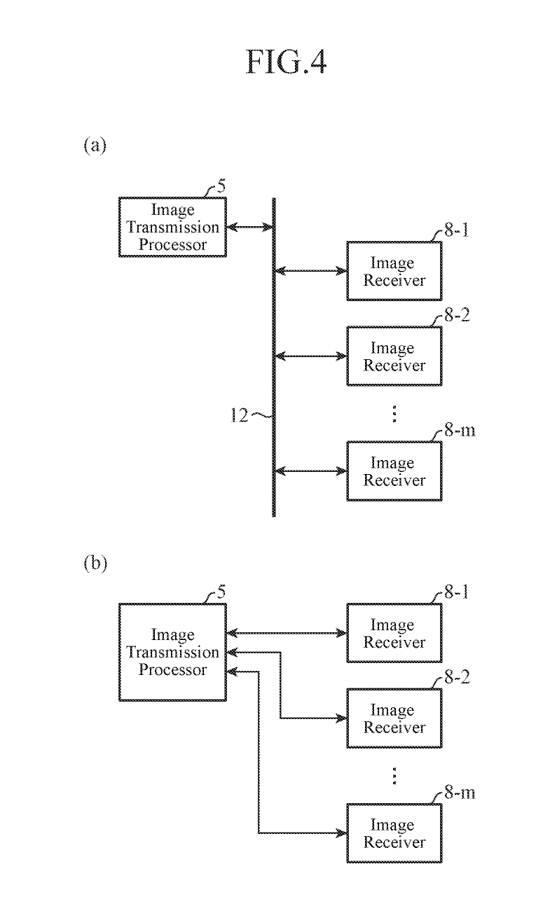

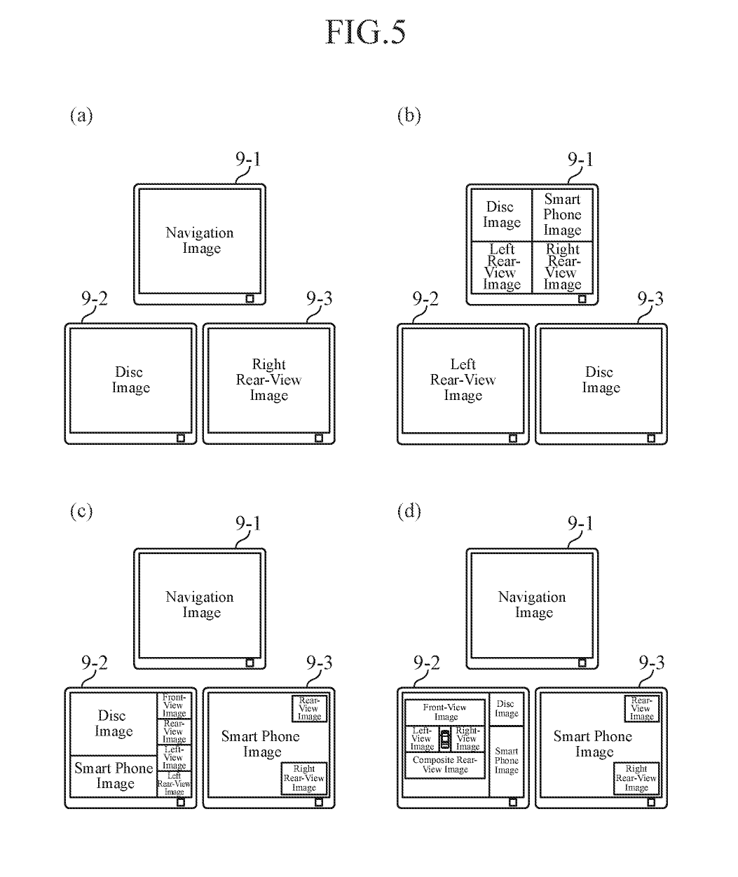

The connection method is not limited to the cascade connection. In an example shown in FIG. 4(a), the image transmission processor 5 is connected to each of the image receivers 8-1 to 8-m via a bus 12. In an example shown in FIG. 4(b), each of the image receivers 8-1 to 8-m is individually connected to the image transmission processor 5. In FIGS. 4(a) and 4(b), the components other than the image transmission processor 5 and the image receivers 8-1 to 8-m are not illustrated.

Each of the displays 9-1 to 9-m is configured in such a way that its screen and a touch panel are integral with each other. Each of the displays 9-1 to 9-m accepts image data outputted from the corresponding one of the image receivers 8-1 to 8-m and produces a screen display of the image data, and outputs, as operation information, a passenger's operational input accepted by the touch panel thereof to the corresponding one of the image receivers 8-1 to 8-m.

Although in Embodiment 1 the touch panel of each of the displays 9-1 to 9-m is used as an operation receiver that accepts a passenger's operational input, an input device, such as a switch, buttons or a voice recognition device, can be alternatively used as the operation receiver.

FIG. 5 shows an example of the screen layouts of the displays 9-1 to 9-3 connected to the image receivers 8-1 to 8-3. When a plurality of images are inputted, screens can be configured freely, as shown in FIG. 5. For example, in each screen one of the plurality of inputted images is displayed, or a plurality of inputted images are arranged in an array and displayed simultaneously as a single integrated screen.

For example, in FIG. 5 (a), the front seat display 9-1 displays only a navigation image, the left rear seat display 9-2 displays only a disc image (e.g., a movie on a DVD), and the right rear seat display 9-3 displays a right rear-view image which is captured by the right rear camera 11-6. The front seat display 9-1 shown in FIG. 5 (b) displays a screen in which a disc image, a smart phone image, a left rear-view image captured by the left rear camera 11-4, and a right rear-view image captured by the right rear camera 11-6 are integrated. In FIG. 5 (c), the left rear seat display 9-2 and the right rear seat display 9-3 display integrated screens, and the areas of displayed images differ from one another. The left rear seat display 9-2 shown in FIG. 5 (d) displays an integrated screen in which images captured by externally-mounted cameras are arranged in an array around an image showing the vehicle viewed from above. A composite rear-view image shown in this figure is one which is acquired by compositing three images captured by the rear camera 11-2, the left rear camera 11-4 and the right rear camera 11-6, in order to eliminate the blind spot behind the vehicle.

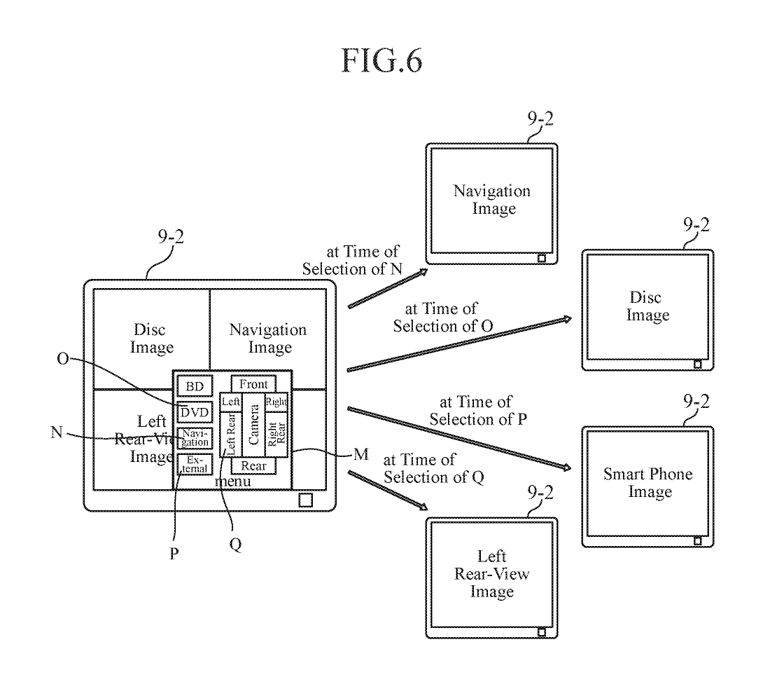

FIGS. 6 to 9 show examples of screen transitions of the left rear seat display 9-2 connected to the image receiver 8-2. As shown in FIGS. 6 to 9, when a passenger selects an image by operating a touch button on the menu screen of the left rear seat display 9-2, or performing a touch operation on the screen, the image is displayed on the entire screen. The selection of an image can be performed in accordance with an operation method using a switch, a button, a voice, or the like, other than the operation of touching a button on the menu screen and the operation of touching the screen.

For example, in FIG. 6, a menu screen M is displayed on the left rear seat display 9-2. When a passenger operates the “navigation” button N on the menu screen M, the left rear seat display 9-2 produces a full-screen display of the navigation image. When a passenger operates the “DVD” button O, the left rear seat display 9-2 performs a full-screen display of the disc image. When a passenger operates the “external” button P, the left rear seat display 9-2 performs a full-screen display of the smart phone image. When a passenger operates the “left rear” button Q, the left rear seat display 9-2 performs a full-screen display of the left rear-view image. Although in FIG. 6 the left rear seat display 9-2 before any button operation is illustrated while being enlarged, in order to make the menu screen M legible, the size of the left rear seat display 9-2 is actually the same before and after any button operation.

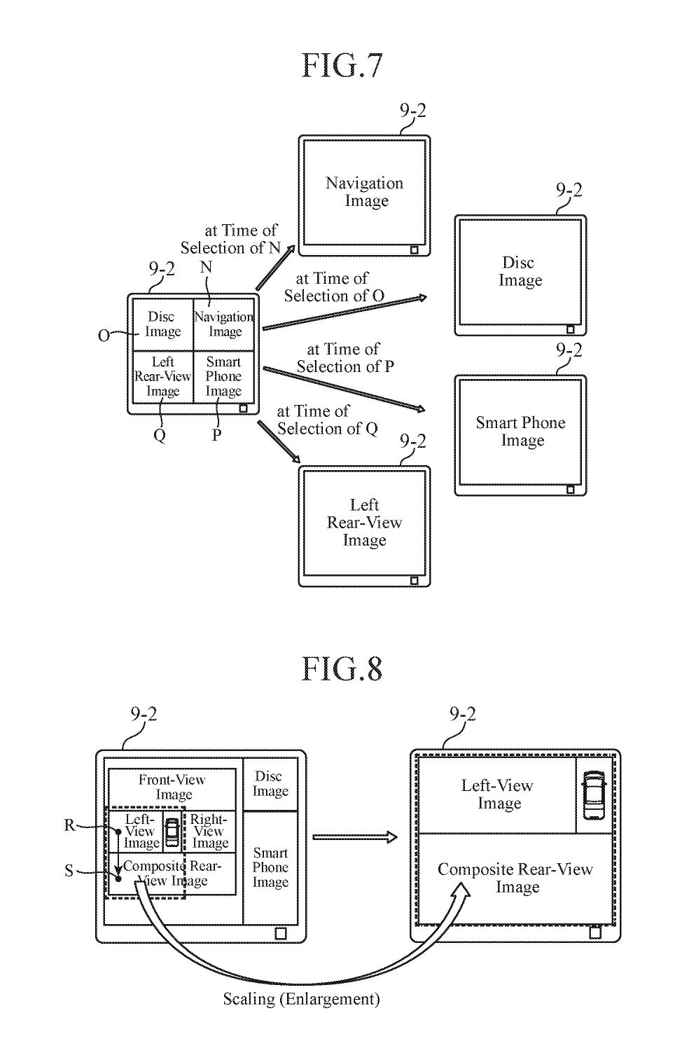

In FIG. 7, an integrated screen in which a navigation image N, a disc image O, a smart phone image P and a left rear-view image Q are integrated is displayed on the left rear seat display 9-2. When a passenger touches the navigation image N, the left rear seat display 9-2 produces a full-screen display of the navigation image. When a passenger touches the disc image O, the left rear seat display 9-2 produces a full-screen display of the disc image. When a passenger touches the smart phone image P, the left rear seat display 9-2 produces a full-screen display of the smart phone image. When a passenger touches the left rear-view image Q, the left rear seat display 9-2 produces a full-screen display of the left rear-view image.

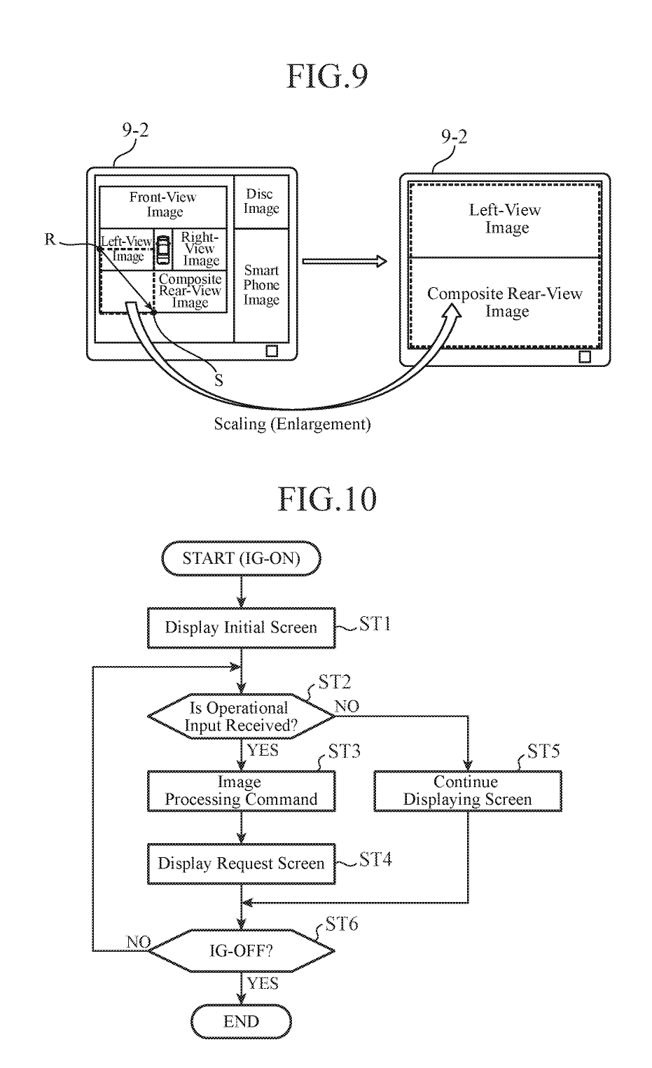

In FIGS. 8 and 9, in a left portion of the left rear seat display 9-2, a screen in which images captured by externally-mounted cameras are arranged around an image showing the vehicle viewed from above is displayed. In the case of FIG. 8, when a passenger traces from a point R to a lower point S on the screen by performing a touch operation, the left rear seat display 9-2 produces, as a single screen, an enlarged display of a left-view image and a composite rear-view image which are selected through the touching operation. In the case of FIG. 9, when a passenger traces from a point R to a point S in a diagonally downward direction on the screen by performing a touch operation, the left rear seat display 9-2 produces, as a single screen, an enlarged display of images specified by a rectangular frame whose diagonal line is defined by the path of the touch operation. As the method of selecting images, for example, there are a method of touching the screen from the point R to the point S on the screen in such a way as to trace from the point R to the point S, and a method of touching the points R and S within a predetermined time period.

Further, when a passenger specifies an area by performing a double tap, a pinch out or the like on the screen using fingers, the display can produce an enlarged display of the specified area in such a way that the specified area is positioned at the center of the screen.

As mentioned above, passengers are enabled to freely select an image which they desire to view from among the images inputted to the vehicle-mounted display device 1 and the composite images, and to cause the vehicle-mounted display device to display the image on a display. For example, when the driver parks the vehicle or makes a lane change, a passenger is enabled to check the surroundings of the vehicle on a display and support the driver. Further, because when a passenger gets out of the vehicle, this passenger is enabled to make certain, on a display, that he or she can do so safely, the driver does not have to care about the getting off.

Next, the operation of the vehicle-mounted display device 1 will be explained.

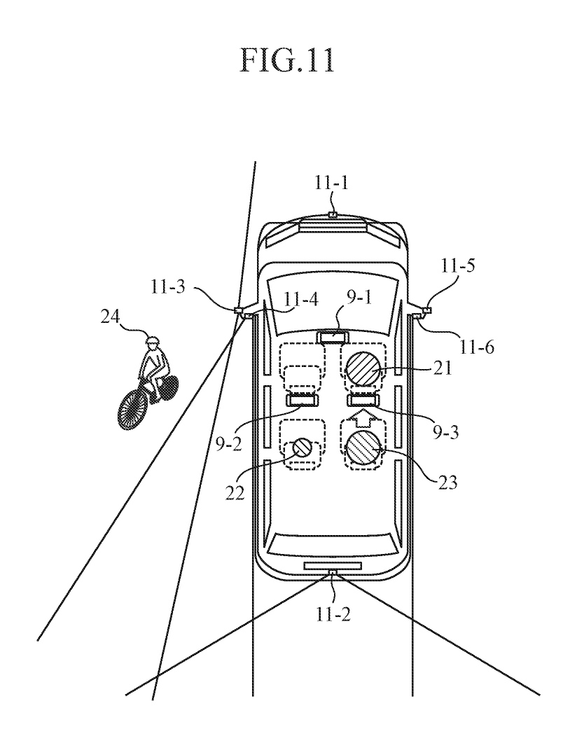

FIG. 10 is a flow chart showing the operation of the vehicle-mounted display device 1. FIG. 11 is a diagram explaining conditions inside and outside the vehicle in which the vehicle-mounted display device 1 is mounted. A driver 21 is sitting in the driver's seat, a left rear-seat passenger 22 who is a child is sitting in the left-hand side of the rear seat, and a right rear-seat passenger 23 who is an adult is sitting in the right-hand side of the rear seat. Further, a person riding on a bicycle (referred to as an approaching object 24 from here on) is moving on the left of the vehicle. It is difficult for the right rear-seat passenger 23 to notify the driver 21 of these conditions with a visual check from the right-hand side of the rear seat when making a notification of the necessity to confirm the safety of the approaching object 24 and obstacles on the left of the vehicle, and so on. Therefore, the right rear-seat passenger 23 visually recognizes a camera image of the surroundings of the vehicle on the right rear seat display 9-3, to perform driving support.

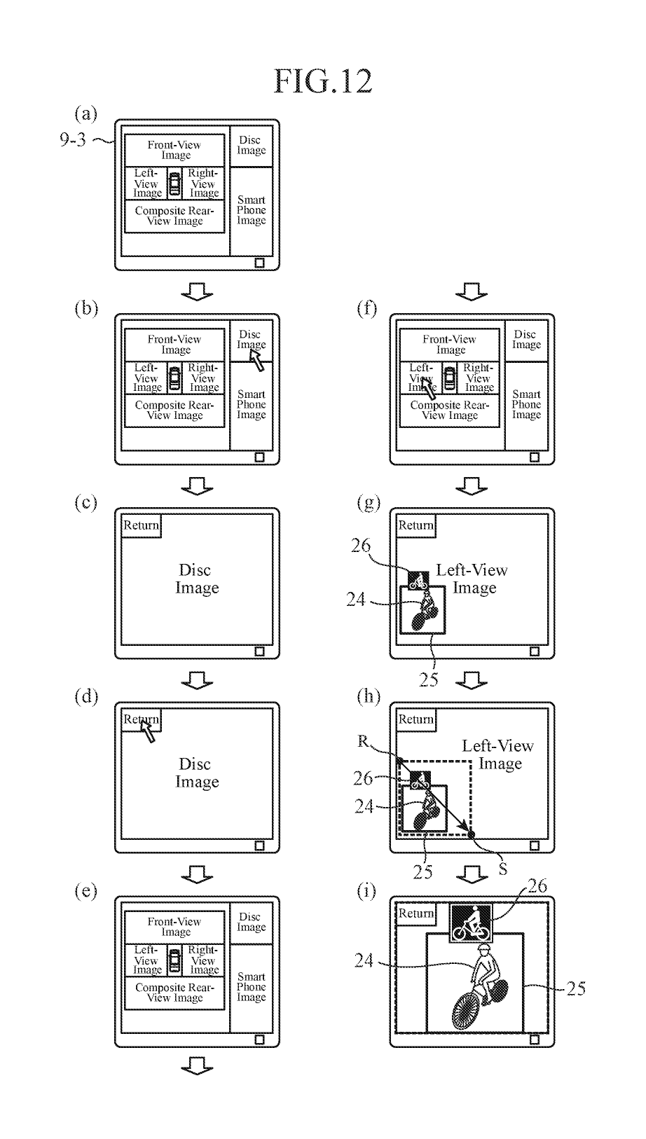

In this situation, a menu operation on the right rear seat display 9-3 which the right rear-seat passenger 23 performs, and screen transitions are shown in FIG. 12.

When the ignition key of the vehicle is set to ON (IG-ON), the vehicle-mounted display device 1 starts and the image processing controller 2a controls each of the units according to the flow chart shown in FIG. 10. First, the image processing controller 2a issues a processing command to display initial screens to the image integration processor 4, to cause the displays 9-1 to 9-m to display the initial screens (step ST1). As shown in FIG. 12 (a), camera images which are captured by shooting the surroundings of the vehicle, a disc image, and a smart phone image are displayed on the right rear seat display 9-3 as its initial screen. At this time, the image integration processor 4 integrates the camera images acquired by the image acquiring units 3-1 to 3-n, the disc image, and the smart phone image, to generate image data for initial screens, and transmits the image data from the image transmission processor 5 to the image receivers 8-1 to 8-m. The image receivers 8-1 to 8-m receive the image data and display the image data on the displays 9-1 to 9-m.

When the right rear-seat passenger 23 performs an operation of selecting the disc image from the initial screen in FIG. 12 (b), the right rear seat display 9-3 accepts this operational input and transmits information about this operation to the image transmission processor 5 (when “YES” in step ST2). In this example, in order to make the operation by the right rear-seat passenger 23 intelligible, the selecting operation is expressed using a cursor.

The image processing controller 2a determines the descriptions of this operation information and commands the image integration processor 4 to generate image data about the disc image (step ST3). The image integration processor 4 performs a graphics process of drawing a button “Return” on the disc image acquired by the image acquiring unit 3-1, to generate image data. The image receiver 8-3 receives this image data via the image transmission processor 5 and displays the image data on the right rear seat display 9-3 (step ST4). In order to return to the initial screen, the button “Return” can be thus displayed, as a graphic, on the screen, or a switch, voice recognition or the like can be alternatively used.

When the ignition key is turned off, the image processing controller 2a ends the screen display (when “YES” in step ST6). In contrast, when the ignition key is in the ON state (when “NO” in step ST6), the image processing controller returns to step ST2, and checks whether the image processing controller has received an input of new operation information (step ST2). When not having received new operation information (when “YES” in step ST2), the image processing controller 2a controls the image integration processor 4 and so on to continue the display of the current screen (in this example, the disc image) (step ST5).

When checking the presence or absence of an approaching object 24 or the like on the left of the vehicle for supporting the driving by the driver 21 while watching the disc image, the right rear-seat passenger 23 first performs an operation of selecting the button “Return” superimposed and displayed on the disc image on the right rear seat display 9-3 (FIG. 12(d)). When accepting operation information about the selection of the initial screen (when “YES” in step ST2), the image processing controller 2a issues a processing command to display the initial screen to the image integration processor 4 (step ST3), and displays the initial screen on the right rear seat display 9-3, as shown in FIG. 12(e) (step ST4).

Next, the right rear-seat passenger 23 performs an operation of selecting the left-view image from the initial screen (FIG. 12(f)). When accepting operation information about the selection of the left-view image (when “YES” in step ST2), the image processing controller 2a issues a processing command to display the left-view image to the image integration processor 4 (step ST3), and causes the right rear seat display 9-3 to produce a screen display of the left-view image, as shown in FIG. 12(g) (step ST4). At this time, when detecting an approaching object 24 from the left-view image, the image integration processor 4 can enclose the approaching object 24 by using a frame line 25 and draw an icon 26, to highlight the approaching object. The right rear-seat passenger 23 supports the driving by providing guidance, advice, a notification of the presence or absence of danger, or the like for the driver 21 while viewing the left-view image displayed on the right rear seat display 9-3.

When desiring to further acquire detailed information (desiring to view a detailed image), the right rear-seat passenger 23 performs an operation of touching the screen of the right rear seat display 9-3 in such a way as shown in FIG. 12(h), to select an area of interest whose vertices are points R and S. When accepting operation information about the selection of the area of interest (when “YES” in step ST2), the image processing controller 2a issues a processing command to enlarge the area of interest to the image integration processor 4 (step ST3), and causes the right rear seat display 9-3 to enlarge and display the area of interest in the left-view image, as shown in FIG. 12(i) (step ST4). As a result, the right rear-seat passenger 23 can support the driving on the basis of the more detailed information. Further, because when an obstacle or an approaching object 24 is existing in the surroundings of the vehicle, the obstacle or the approaching object is highlighted on the screen, the right rear-seat passenger 23 can provide support further avoiding danger for the driver. In addition, when an object like an obstacle or an approaching object 24 is existing in the surroundings of the vehicle, the right rear-seat passenger 23 can cause the right rear seat display 9-3 to produce an enlarged display of the object on the left-view image, thereby being able to determine whether or not the object can be an obstacle to the travelling and notify the driver 21 of the object.

Further, when the left rear-seat passenger 22 who is a child gets out of the vehicle, the right rear-seat passenger 23 who is an adult can cause the right rear seat display 9-3 to display the left-view image, to perform a safety check. In addition, when an obstacle or an approaching object 24 is existing in the surroundings of the vehicle at the time that a passenger gets out of the vehicle, the vehicle-mounted display device 1 can lock a door of the vehicle, to prevent the passenger from getting out of the vehicle. Concretely, when the image integration processor 4 detects an approaching object 24 approaching the vehicle from a camera image which is acquired by shooting the surroundings of the vehicle, the vehicle control commander 2b acquires information about the detection from the image integration processor 4 and transmits a command to lock the door on the side of the vehicle where the approaching object 24 has been detected to the vehicle controller 10. When receiving the door locking command from the vehicle control commander 2b via the in-vehicle network, the vehicle controller 10 locks the door which is the target for the command.

Next, a detailed operation of the vehicle-mounted display device 1 will be explained.

Hereafter, a case in which the number of inputted images is four (n=4), and the number of outputted images is three (m=3) will be explained. The image acquiring unit 3-1 acquires a disc image, the image acquiring unit 3-2 acquires a navigation image, the image acquiring unit 3-3 acquires a left rear-view image of the left rear camera 11-4, and the image acquiring unit 3-4 acquires a rear-view image of the rear camera 11-2. For the sake of simplicity, it is assumed that the definition and the frame rate of each inputted image are 720×480 pixels and 30 fps, respectively.

The image receiver 8-1 outputs image data to the front seat display 9-1, the image receiver 8-2 outputs image data to the left rear seat display 9-2, and the image receiver 8-3 outputs image data to the right rear seat display 9-3. It is assumed that the definition of the displays connected to the image receivers 8-1 to 8-3 is WVGA (800×480 pixels).

Each of the image acquiring units 3-1 to 3-4 performs A/D conversion, format conversion, etc. on the inputted image, and outputs this image to the image integration processor 4. When, for example, the inputted image is an analog signal, each of the image acquiring units 3-1 to 3-4 converts this analog signal into a digital signal. In the case of a luminance/chrominance (YUV/YCbCr color space) format, each of the image acquiring units converts the color format into an RGB format.

The color conversion and the format conversion can be carried out by the image integration processor 4, instead of each of the image acquiring units 3-1 to 3-4.

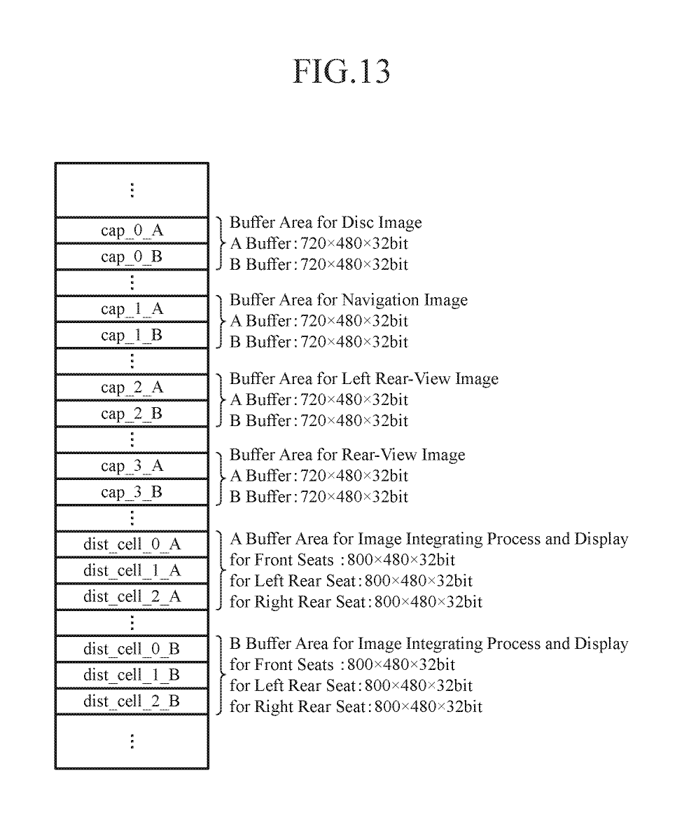

FIG. 13 shows an example of settings of buffers for performing an image grabbing process and the image integrating process by using the image integration processor 4. The image integration processor 4 first performs a buffer setting for grabbing the images outputted by the image acquiring units 3-1 to 3-4 into the memory 6a. Each buffer is comprised of a double buffer (A buffer and B buffer). The image integration processor 4 constructs a buffer for disc image from a double buffer (A buffer and B buffer), and allocates buffer areas (cap_0_A and cap_0_B). In the same way, the image integration processor allocates a buffer for navigation image (cap_1_A and cap_1_B), a buffer for left rear-view image (cap_2_A and cap_2_B), and a buffer for rear-view image (cap_3_A and cap_3_B).

At this time, the buffer size of each of the A and B buffers is the definition of the inputted image×the gradation number×the number of inputted images.

The image integration processor 4 then sets a buffer for image integrating process and display in the memory 6a. In order to display three screens each having definition of WVGA, each of the A and B buffers has a size of (the definition of the outputted image×the gradation number×the number of outputted images). The image integration processor 4 sets an A buffer (dist_cell_0_A, dist_cell_1_A and dist_cell_2_A), and a B buffer (dist_cell_0_B, dist_cell_1_B and dist_cell_2_B) as the buffer for image integrating process and display.

The image integration processor 4 then sets an A buffer (cap_0_A) as a buffer for image grabbing of the buffer for disc image, and sets a B buffer (cap_0_B) as a buffer for image reading of the buffer for disc image. The image integration processor 4 first determines whether or not the buffer A is performing an operation of grabbing the disc image as the operation of grabbing an inputted image. When the buffer A is grabbing the disc image, the image integration processor does not perform any switching on the buffers and does not change the setting of each buffer. When the grabbing is completed, the image integration processor switches the buffer for image grabbing from the A buffer to the B buffer and also switches the buffer for image reading from the B buffer to the A buffer, and starts another grabbing operation. After starting the other grabbing operation, the image integration processor stops this grabbing operation when the image grabbing for one 720×480-pixel screen is completed. After that, the image integration processor repeats the process of starting an image grabbing operation, the process of acquiring one frame, and the process of stopping the grabbing operation. The image integration processor 4 also performs the same processes on the navigation image, the left rear-view image and the rear-view image.

The image integration processor 4 then performs the image integrating process. The image integration processor 4 performs image converting processes (enlargement, reduction, rotation, reflection, etc.) and a compositing process, descriptions of the image converting processes and the compositing process being specified by the image processing controller 2a, by using the disc image, the navigation image, the left rear-view image and the rear-view image which are stored in the buffers for image reading, and stores resultant images in the buffers for image integrating process and display. In this embodiment, because the left rear-view image input has 720×480 pixels and the image display output has 800×480 pixels, a part of the image display output, the part having a lateral width of 80 pixels, is colored black and the image display output is displayed in the same size as the left rear-view image input. As an alternative, the image integration processor can perform definition conversion on the left rear-view image input, to display a laterally-long image as the image display output. Further, four inputted images can be arranged and displayed vertically and horizontally in a tile array (e.g., the display screen of the left rear seat display 9-2 show in FIG. 5 (b)). In this case, because one quarter of a screen size of 800×480 pixels is 400×240 pixels, the image integration processor performs definition conversion on each inputted image in such a way that its screen size is changed from 720×480 pixels to 400×240 pixels, and integrates the image data about the four images into image data about images in a tile array. As shown in FIG. 5, the image integration processor can integrate an arbitrary number of inputted images each having an arbitrary size into a single integrated screen. Further, when the grabbing of each inputted image is not completed at the time of performing the image integrating process, the image integration processor 4 uses the data about the preceding frame, whereas when the grabbing is completed, the image integration processor 4 performs the integrating process by using the data about the current frame on which the grabbing is completed.

Further, the image integration processor 4 has a graphics processing function of performing menu screen generation, highlighting of an obstacle and an approaching object, image processing, etc., and performing superimposition on an inputted image. The graphics processing includes, for example, point drawing, line drawing, polygon drawing, rectangle drawing, color fill, gradation, texture mapping, blending, anti-aliasing, an animation, a font, drawing using a display list, and 3D drawing.

Further, the image integration processor 4 detects an approaching object and an obstacle from each inputted image, and superimposes a display effect (highlighting, a box, coloring, or the like), an icon, a warning message, or the like onto the approaching object and the obstacle on the basis of the detection result and by using the above-mentioned graphics processing function.

After completing the series of image integrating processes, the image integration processor 4 waits for a vertical synchronizing signal for display, to switch the buffer for image integrating process and display from the buffer A to the buffer B. The vertical synchronizing signal is outputted by, for example, the image processing controller 2. When the frame rate of the displays is 60 fps, the vertical synchronizing signal has a frequency of one cycle per 1/60 seconds. When the image integrating process is not completed within the one-frame time interval, the image integration processor 4 waits for the next vertical synchronizing signal, to switch the buffer.

In this case, the frame rate for image update is 30 fps.

After that, the image integration processor 4 outputs the image data to be displayed on the front seat display 9-1, the left rear seat display 9-2 and the right rear seat display 9-3 to the image transmission processor 5.

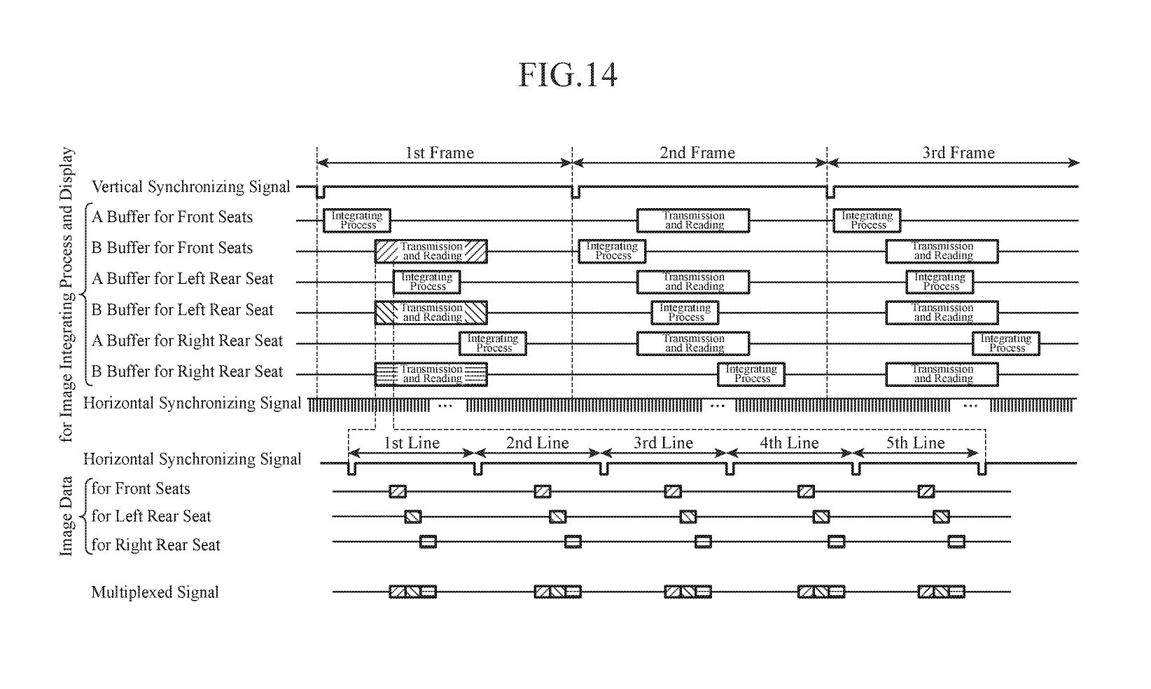

FIG. 14 is a timing chart showing operations on a frame by frame basis (vertical synchronization) and on a line by line basis (horizontal synchronization) of the image integration processor 4 and the image transmission processor 5, and the horizontal axis shows a time.

While the image integration processor 4 performs the image integrating process by using the A buffer, the image integration processor 4 outputs the image data stored in the B buffer to the image transmission processor 5. In contrast, while the image integration processor performs the image integrating process by using the B buffer, the image integration processor outputs the image data stored in the A buffer to the image transmission processor 5. In this embodiment, in order to display the image data on the three displays 9-1 to 9-3, the image transmission processor 5 multiplexes the image data about three images for each horizontal line, and transmits a multiplexed signal to the image receivers 8-1 to 8-m.

Next, the operation of the image transmission processor 5 will be explained. Data transmission between the image transmission processor 5 and the image receivers 8-1 to 8-m is performed in both directions. Hereafter, transmission from the image transmission processor 5 to the image receivers 8-1 to 8-m is referred to as downlink transmission, and transmission from the image receivers 8-1 to 8-m to the image transmission processor 5 is referred to as uplink transmission. At the time of downlink transmission, the image transmission processor 5 packetizes the multiplexed signal of the image data about each line, which is received from the image integration processor 4, into a plurality of packet data, and adds header information (a packet header) to each packet data and sends this packet data to the image receivers 8-1 to 8-m. The header information includes a packet ID, a line number, a data destination (identification information identifying one of the image receivers 8-1 to 8-m), and the size of the image data.

At the time of uplink transmission, the image transmission processor 5 receives headers and packet data from the image receivers 8-1 to 8-m, to acquire the status information about each of the image receivers 8-1 to 8-m. Each header information includes a packet ID, a line number, and a data sending source (identification information identifying one of the image receivers 8-1 to 8-m). Each packet data does not include image data, but includes status information showing the status of one of the image receivers 8-1 to 8-m (a communication state, error information, and information about connection with the corresponding one of the displays 9-1 to 9-m), and operation information. The image transmission processor 5 stores the status information and the operation information received and acquired thereby in the memory 6b.

Next, the operations of the image receivers 8-1 to 8-m will be explained.

The image receiver 8-1 which is the top of the image receivers 8-1 to 8-m cascaded, as shown in FIG. 1, at the time of downlink transmission, receives a packet header and packet data from the image transmission processor 5, determines whether or not the packet data is destined therefor, on the basis of the header information included in the packet header, to receive only packet data destined therefor, and displays the image data included in the received packet data on the display 9-1. The image receiver 8-1 does not receive any packet data other than that destined therefor, and sends out the packet header and the packet data to the image receiver 8-2 connected as a stage following the image receiver 8-1 itself. The image receiver 8-1 also sends out its status information and operation information to the image transmission processor 5 as uplink transmission.

Similarly, also the image receiver 8-2 receives only packet data destined therefor from among the packet data transmitted from the image receiver 8-1 on a higher order side thereof and displays the image data included in the received packet data on the display 9-2, and also sends out its status information and operation information to the image transmission processor 5 via the image receiver 8-1.

After that, each of the image receivers 8-3 to 8-m performs the same processes, too.

As mentioned above, the vehicle-mounted display device 1 according to Embodiment 1 is configured in such a way as to include the plurality of displays 9-1 to 9-m mounted in the vehicle, the plurality of operation receivers (e.g., touch panels) respectively corresponding to the plurality of displays 9-1 to 9-m, the image acquirer 3 to acquire a plurality of camera images from the plurality of externally-mounted cameras that shoot the surroundings of the vehicle, the image processing controller 2a to, when one of the operation receivers accepts a passenger's operation of selecting a camera image to be displayed on the corresponding one of the displays 9-1 to 9-m from among the plurality of camera images, issue an image processing command to generate image data to be displayed on the display corresponding to the above-mentioned operation receiver, and the image integration processor 4 to, for each of the plurality of displays 9-1 to 9-m, select a camera image to be displayed on the above-mentioned display from among the plurality of camera images according to the image processing command from the image processing controller 2a, to generate the image data. Therefore, a passenger sitting in the seat next to the driver or a rear seat is enabled to freely select a camera image of the surroundings of the vehicle on the display mounted for the seat and cause the display to display the selected camera image.

Therefore, any passenger is enabled to provide driving support, such as guidance, advice, or a notification of the presence or absence of danger, for the driver including a person unaccustomed to driving, such as a beginner driver, an elderly driver or a driver in name only, from any seat in the vehicle, and hence this vehicle-mounted display device can provide a safer driving environment.

Further, the vehicle-mounted display device according to Embodiment 1 is configured in such a way that when one of the operation receivers (e.g., touch panels) accepts a passenger's operation of selecting a part of first image data displayed on the corresponding one of the displays 9-1 to 9-m, the image processing controller 3a issues an image processing command to enlarge the above-mentioned part, and the image integration processor 4 composites a plurality of camera images to generate the first image data (e.g., the composite rear-view image shown in FIG. 8), and generates second image data in which the part of the first image data is enlarged, according to the image processing command. Therefore, a passenger is enabled to select an area of interest which he or she desires to view from a composite image into which a plurality of cameras image are composited and cause a display to produce a full-screen display of the area of interest. Further, the vehicle-mounted display device can eliminate blind spots of the externally-mounted cameras by compositing a plurality of camera images.

Further, according to Embodiment 1, because the second image data in which the part of the above-mentioned first image data is enlarged includes at least two camera images, as shown in FIGS. 8 and 9, the image processing controller can cause the display to display the plurality of images which the passenger desires to view at one time.

Further, because the image integration processor 4 according to Embodiment 1 detects an approaching object 24 approaching the vehicle by using the plurality of camera images, and superimposes information showing a warning about an approach of the above-mentioned approaching object onto the image data, the vehicle-mounted display device makes it easy for the passenger to notice the object (e.g., another vehicle, a motorbike, a bicycle, a pedestrian, or the like) approaching the vehicle.

Further, according to Embodiment 1, because the information showing a warning about an approach of an object is highlighting, the passenger can intuitively recognize the approaching object by viewing the screen display. As the highlighting, a method of providing a warning using characters, or the like, as well as a method of enclosing the approaching object by using a frame line, can be used.

Further, the vehicle-mounted display device according to Embodiment 1 is configured in such a way that when one of the operation receivers (e.g., touch panels) accepts a passenger's operation of selecting a part of first image data displayed on the corresponding one of the displays 9-1 to 9-m, the image processing controller 3a issues an image processing command to enlarge the above-mentioned part in a central portion of the screen of the corresponding one of the displays 9-1 to 9-m, and the image integration processor 4 generates the first image data in which the plurality of cameras image are arranged in an array (e.g., the integrated screen shown in FIG. 8 in which the left-view image and the composite rear-view image are arranged in an array), and generates second image data in which the part of the first image data is enlarged and displayed in the central portion of the screen of the display, according to the image processing command. Therefore, the vehicle-mounted display device enables any passenger to perform a simple operation such as an operation of enclosing or performing double-tap or pinch-out on an area of interest, which the passenger desires to view, by using a finger, thereby causing a display to produce an enlarged display of the area of interest, and can thus implement intuitive and intelligible operations. Further, because the vehicle-mounted display device produces an enlarged display of the selected area of interest in the central portion of the screen, the vehicle-mounted display device can prevent the approaching object or the like from disappearing from the screen even if the vehicle-mounted display device produces an enlarged display of the approaching object or the like.

While the present invention has been described in its preferred embodiment, it is to be understood that various changes can be made in an arbitrary component according to the embodiment, and an arbitrary component according to the embodiment can be omitted within the scope of the invention.

### INDUSTRIAL APPLICABILITY

As mentioned above, because the vehicle-mounted display device according to the present invention changes the image to be displayed on a display in accordance with a passenger's operation, the vehicle-mounted display device is suitable for use for driving support that makes it possible for a passenger to perform a safety check on the surroundings of a vehicle on the display, and provide a notification or the like for the driver.

### EXPLANATIONS OF REFERENCE NUMERALS

1 vehicle-mounted display device, 2 CPU, 2a image processing controller, 2b vehicle control commander, 3 image acquirer, 3-1 to 3-n image acquiring unit, 4 image integration processor, 5 image transmission processor, 6a and 6b memory, 7 internal bus, 8-1 to 8-m image receiver, 9-1 to 9-m display, 10 vehicle controller, 12 bus, 11-1 to 11-6 camera, 21 driver, 22 left rear-seat passenger, 23 right rear-seat passenger, 24 approaching object, 25 frame line, and 26 icon.

1. A vehicle-mounted display device comprising:
a plurality of displays mounted in a vehicle while being brought into correspondence with a plurality of seats including a rear seat;
a plurality of operation receivers respectively corresponding to said plurality of displays;
an image acquirer to acquire a plurality of camera images from a plurality of externally-mounted cameras that shoot surroundings of said vehicle;
an image processing controller to, when one of said plurality of operation receivers accepts an operation, by a passenger sitting in said rear seat, of selecting a camera image to be displayed on a corresponding one of said plurality of displays from among said plurality of camera images, issue an image processing command to generate image data to be displayed on said corresponding display; and
an image integration processor to, for each of said plurality of displays, select a camera image to be displayed on said each of said plurality of displays from among said plurality of camera images according to said image processing command from said image processing controller, to generate said image data.

2. The vehicle-mounted display device according to claim 1, wherein when said operation receiver accepts an operation, by a passenger sitting in said rear seat, of selecting a part of first image data displayed on said display, said image processing controller issues an image processing command to enlarge said part, and wherein said image integration processor composites said plurality of camera images to generate said first image data, and generates second image data in which said part of said first image data is enlarged, according to said image processing command.

3. The vehicle-mounted display device according to claim 2, wherein said second image data includes at least two of said camera images.

4. The vehicle-mounted display device according to claim 1, wherein said image integration processor detects an object approaching said vehicle by using said plurality of camera images, and superimposes information showing a warning about an approach of said object onto said image data.

5. The vehicle-mounted display device according to claim 4, wherein the information showing a warning about an approach of said object is highlighting.

6. The vehicle-mounted display device according to claim 1, wherein when said operation receiver accepts an operation, by a passenger sitting in said rear seat, of selecting a part of first image data displayed on said display, said image processing controller issues an image processing command to enlarge said part in a central portion of a screen of said display, and wherein said image integration processor generates said first image data in which said plurality of cameras image are arranged in an array, and generates second image data in which said part of said first image data is enlarged and displayed in the central portion of the screen of said display, according to said image processing command.
